(19) United States
(12) Patent Application Publication
(10) Pub. No.: US 2015/0379584 A1
(43) Pub. Date: Dec. 31, 2015

(54) Advertising Platform for Ad Placement

(71) Applicants: Marc Trachtenberg, New York, NY (US); Francois Gariepy, Westmount (CA); Ketan Patel, Warren, NJ (US)

(72) Inventors: Marc Trachtenberg, New York, NY (US); Francois Gariepy, Westmount (CA); Ketan Patel, Warren, NJ (US)

(21) Appl. No.: 14/788,189

(22) Filed: Jun. 30, 2015

Related U.S. Application Data
(60) Provisional application No. 62/019,155, filed on Jun. 30, 2014.

(51) Int. Cl. G06Q 30/02

(52) U.S. Cl. CPC G06Q 30/0275

(57) ABSTRACT

A digital advertising system for displaying and optimizing revenue of at least one advertisement having bidding and rating information comprising at least one display device with a processor, a memory, and a profile containing attributes of the at least one display device, an advertising platform adapted to receive said bidding and rating information associated with the at least one advertisement and to use the profile and the bidding and rating information to determine the placement of the at least one advertisement on the at least one display device, and an exchange adapted to securely access the advertising platform and the at least one display device to govern the flow of data and control between the advertising platform and the at least one display device.

### RELATED APPLICATIONS

This application claims priority to U.S. Provisional Patent Application Ser. No. 62/019,155 filed on Jun. 30, 2014 and U.S. patent application Ser. Nos. 14/213,729, 14/213,773, 14/213,810, 14/213,873, 14/213,918, 14/213,956, 14/213,981, and 14/214,017, all filed on Mar. 14, 2014, the disclosures and teachings of which are all incorporated herein by reference.

### FIELD OF THE INVENTION

The present invention represent is a digital advertising platform that maximizes pricing and revenue opportunities throughout various market spaces.

### SUMMARY OF THE INVENTION

A digital advertising system for displaying and optimizing revenue of at least one advertisement having bidding and rating information comprising at least one display device with a processor, a memory, and a profile containing attributes of the at least one display device, an advertising platform adapted to receive said bidding and rating information associated with the at least one advertisement and to use the profile and the bidding and rating information to determine the placement of the at least one advertisement on the at least one display device, and an exchange adapted to securely access the advertising platform and the at least one display device to govern the flow of data and control between the advertising platform and the at least one display device.

### BRIEF DESCRIPTION OF THE DRAWINGS

FIG. 1 discloses a high level view of the Exchange ecosystem which includes a number of Constellations that are federated by the Exchange;

FIG. 2 illustrates the interaction of the exchange and advertising platform systems with the display surfaces and users;

FIG. 3 illustrates the Exchange portal interface to Exchange Operations, Constellation Operations and Display Surface Operator users;

FIG. 4 illustrates the user interface of the advertising portal to the Advertising Portal Operations and Advertiser types of users;

FIG. 5 shows the Exchange infrastructure;

FIG. 6 is an overview of the advertising platform showing its four main functionalities: Media Content Management, Advertisement Control, Advertisement Placement and Reporting;

FIG. 7 illustrates the two processes of the Ad Logic flow, specifically the off-line Campaign Builder process and the real-time bid/buy evaluation process; and

FIG. 8 shows an overview of the display device or surface components along with the flow of information into and out of the specific components.

### DETAILED DESCRIPTION

The present invention is a digital advertising platform that maximizes pricing and revenue opportunities throughout various market spaces. The end-to-end system combines innovations in displays, accessibility, audience targeting, governance, responsive ad options and market intermediation.

The three basic building blocks of the Exchange system are the Exchange itself—the constellation federating hub—, the advertising intermediation platform, and distinct groups of display surfaces. The Exchange allows distinct groups of Display Surfaces (herein called Constellations) to securely access the advertising platform to provide profile and metadata information and receive advertising media and controls. The advertising platform is a dis-intermediated dynamic advertising platform using bidding and rate sheets to determine advertising media content placement which allows Advertisers to acquire display time (called Viewing Slot) on various types of Display Surfaces through a fixed rate or bidding process. A Dis-intermediated platform is one in which intermediaries are removed from the advertising placement supply chain; i.e., the advertiser uses the Advertising Portal of the present invention to place advertising directly without going through a series of brokers, aggregators and agents. The Advertising Portal is configured to continuously reflect the latest status and conditions and changes and adapts with each user input. Constellations are groupings of Display Surfaces that are registered with and driven from the advertising platform.

Display Surfaces are devices capable of displaying visual content. A special category of Display Surfaces have the unique capability to run advertising apps that enable autonomous operations of the Display Surface. Advertising applications can react to surrounding of the Display Surface (including other collaborating Display Surfaces), adjust displayed media or interaction with proximity devices accordingly and affect the outcome of advertising placement decisions. These Display Surfaces are preferably either (1) an external hardware component driving a standard display through its HDMI port or (2) a specially designed display devices which embeds the same hardware components. This category of Display Surfaces are fully described and shown in U.S. patent application Ser. Nos. 14/213,729, 14/213,773, 14/213,810, 14/213,873, 14/213,918, 14/213,956, 14/213,981, and 14/214,017, all filed on Mar. 14, 2014, the disclosures and teachings of which are all incorporated herein by reference.

The platform provides Advertisers with a suite of tools to create and manage their advertising campaigns, made of advertising media and Viewing Slots on Display Surfaces, in near real-time. Advertising media is created using an automated workflow and suite of tools accessible through the platform portal that allows Advertiser to create and ingest advertising media content and optimize such content for targeted Display Surfaces. A Viewing Slot on display surfaces is acquired through a negotiated fixed Rate Sheet or bidding process managed through the Campaign Builder tools of the portal. Finally, Advertisers monitor their campaign in near-time using a series of dashboarding, reporting and analytics tools also available through the portal. An extended suite of monitoring tools is also used by operations specialists to ensure peak performance of the present invention system at all time. Owner/operators of Display Surfaces also use a similar suite of monitoring tools to track usage of their display asset inventory.

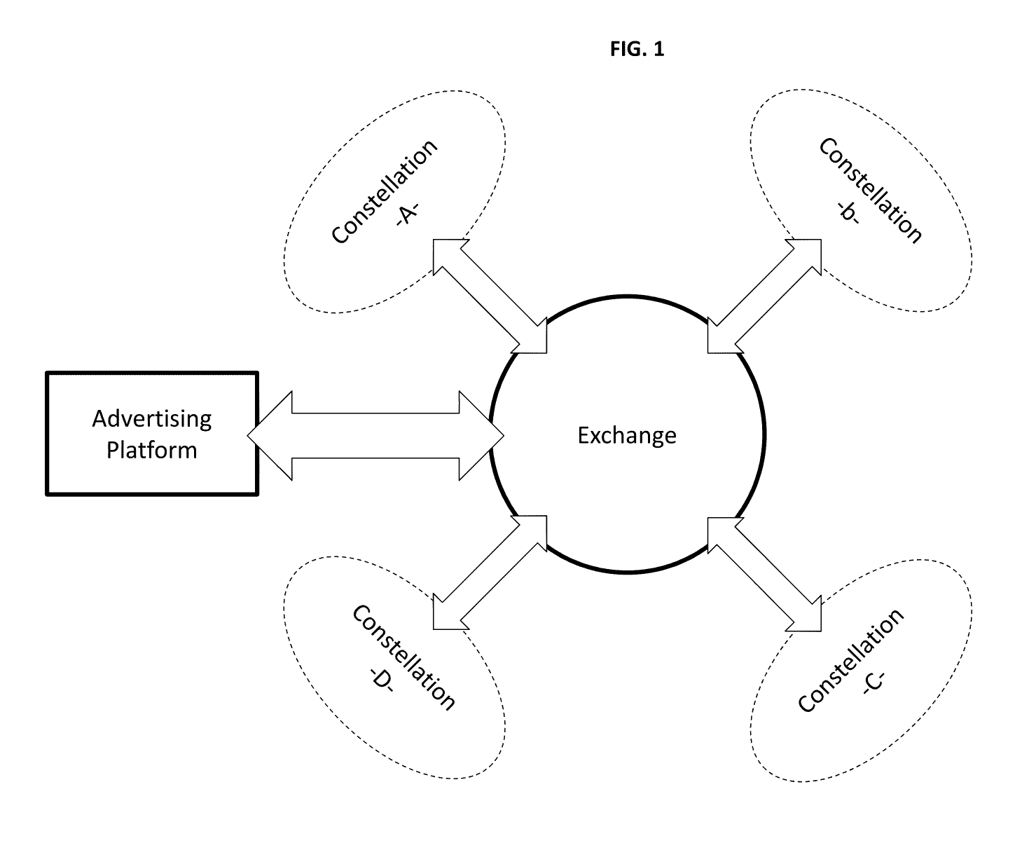

FIG. 1 discloses a high level view of the Exchange ecosystem which includes a number of Constellations that are federated by the Exchange. The advertising media content displayed on each Display Surfaces belonging to the Constellations are managed by the advertising platform through the Exchange.

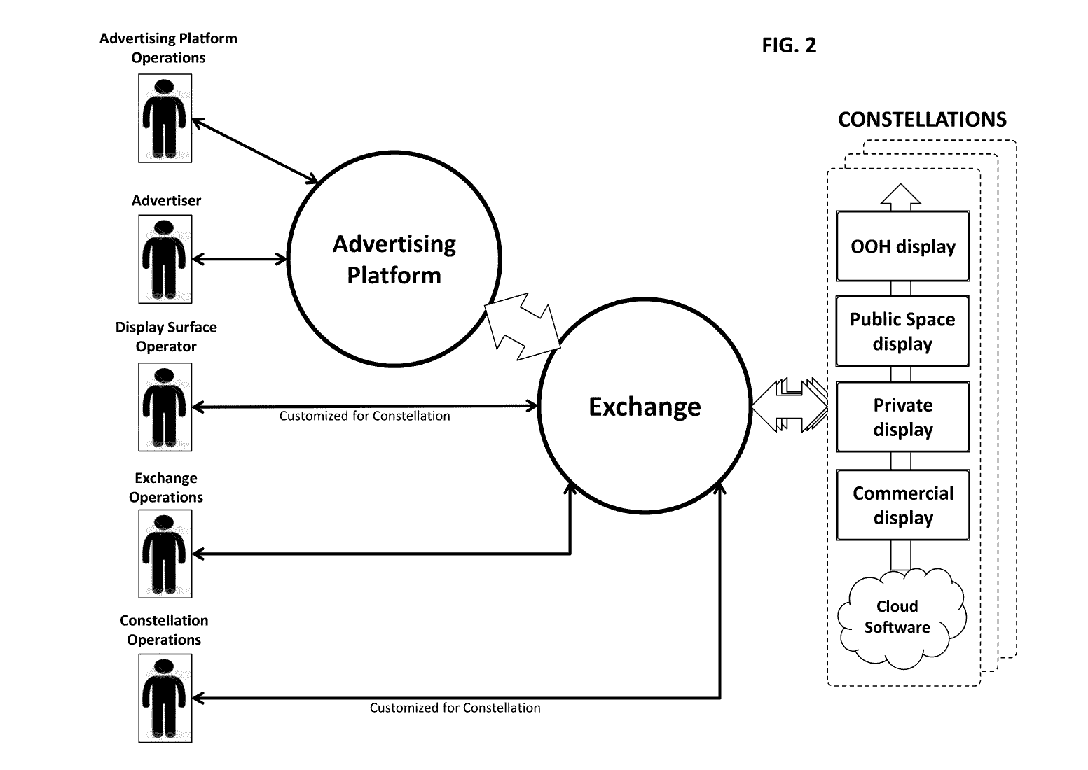

As seen in FIG. 2, the Exchange and advertising platform systems interact with four primary types of Display Surfaces and 5 types of users. Exchange federates and the platform manages four primary types of Displays: (1) Out-Of-Home (OOH) display surfaces, (2) Public Space Display surfaces (3) Private Display surfaces and (4) Commercial Display surfaces. Each type is grouped under its own Constellation. Three user types interact directly with the Exchange Portal: Exchange Operations, Constellation Operations and Display Surface Operator. And two types of users interact with the Advertising Portal: Advertising Platform Operations and Advertiser. Federating is defined as transparently aggregating multiple autonomous information structures into a single information structure as seen by an external party. Federation engines are generally used to hide the complexity of data structures or their inner workings from a third party that needs access to some of that data.

Five categories of users are using the present invention exchange and platform to create, manage and operate advertising campaigns or register and manage Display Surfaces. As seen in FIG. 2, they are:

1. Exchange operations

2. Constellation operations

3. Advertising Platform operations

4. Advertisers

5. Display Surface operators

Activities of each type of user are strictly controlled by profile, settings and privileges associated to their account type.

Exchange operations is responsible for ensuring security, continuity and peak performance operations of the Exchange and delivering general technical support through a suite of tools available through the Exchange Portal. These tools include performance indicator live dashboard and reporting and aggregated views of federated Display Surfaces. Exchange Operations also arbitrate revenues between various federated constellations and advertising platform. Finally Exchange Operations collects massive amount of user data that is analyzed through “big data” analytics tools to provide insight on user preferences and performance metrics.

Constellation operations are responsible to register, maintain and operate a group of Display Surfaces that are governed by a common set of rules and federated with other constellations through the Exchange.

Platform operations are responsible for ensuring continuity and peak performance of the advertising platform service. Four primary types of Platform Operations accounts are available:

1. Onboarding administrator: responsible for proper registration of Display Surfaces.

2. TechOps Support: responsible for technical support of the various components of the platform service.

3. Revenue Administrator: responsible for pricing and revenue sharing arbitration.

4. Media compliance specialist: responsible for reviewing, rating and approving advertising media content before it is linked to an advertising campaign.

Advertisers represent the various types of users that are involved in the creation and management of an advertising campaign. As a minimum, the following types of accounts are available:

1. Campaign builder

2. Campaign reviewer

3. Content creator

4. Campaign operator

Display Surface operators are users that register and manage devices with the Exchange and Advertising Platform system. Four primary types of Display Surface Operator accounts are available:

1. OOH display operator

2. Public Space display operator

3. Private display operator

4. Commercial display operator

A Display Surface designates all display devices that can display advertising content. The operator of each Display Surface can register each display surface with the advertising platform service and create a Display Surface Profile that is used by the platform service to promote the value of the Display Surface with advertisers and manage its operations.

The Display Surface Profile preferably comprises a static profile made of attributes created as part of the Display Surface registration process or updated from time to time, i.e., on a requirement basis, but not continuously or on a regular schedule, and a dynamic profile that is made of attributes that are updated in real-time, so that the system reacts immediately when a change occurs or an input is made. The static profile preferably incorporates attributes such as unique designation, device type, constellation and industry belonging, media capability, establishment, relative location, viewing conditions, general demographics, content preferences as well as historical impressions, conversion and acquisition rates and user reviews. The attributes of the dynamic profile preferably include absolute location, demographics of the establishment/location over time and changing viewing conditions over time. The detailed and dynamic Display Surface profile preferably allows an advertiser to fully comprehend the characteristics of a specific Display Surface and assess its relevancy and value for a specific advertising campaign, viewing conditions. Integrated to an unrestricted search framework is a key, it becomes a key differentiator of the system. It enables Display Surface Finder to compute a precise Ad Relevancy index that greatly facilitates identification of best Display Surfaces to target specific demographics and advertising campaign objectives, considering static as well as dynamic factors.

The advertising platform of the present invention supports three types of display devices:

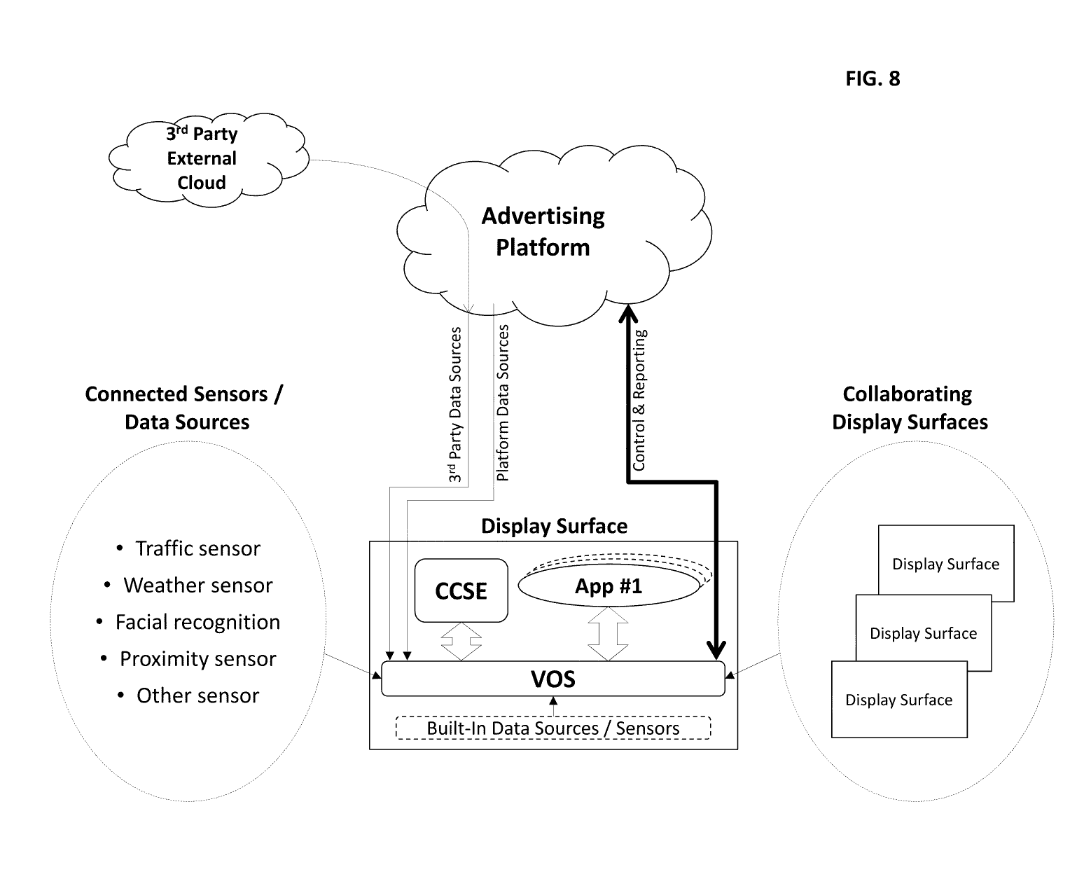

1. Standard Display Device. The present invention is configured to preferably work with the Display Devices disclosed in U.S. patent application Ser. Nos. 14/213,729, 14/213,773, 14/213,810, 14/213,873, 14/213,918, 14/213,956, 14/213,981, and 14/214,017, all filed on Mar. 14, 2014, the disclosures and teachings of which are incorporated herein by reference. The Display Device incorporates native platform support through its embedded digital signage system engine and Operating System (VOS), as disclosed in FIG. 8. The digital signage engine is a complex software system made up of a client and servers, and is used to create advertising content and display on screens. It does not embed the intelligence to decide what is advertised when and where, but preferably simply displays the content that the operators manually decide to display.

2. The Display Device, such as that described in the applications incorporated by reference above, delivers an ultra-thin form factor, light weight, low power, easy deployment and lower cost compared to traditional displays and are available for indoor and outdoor applications—outdoor version of the Display Device is IP4-certified. Its powerful processor and unique VOS preferably allow it to deliver full 1080 p video resolution, vibrant graphics rendering, wireless audio and the ability to execute apps which uses input from the network, built-in motion/inertia, orientation, geo-tagging and proximity sensors as well as BTLE/iBeacon to adapt or react to its environment and deliver pin-point focused advertising media always adapted to its context.

3. Display Device Vision Plus. The Display Device Vision Plus is a compact, self-contained product that incorporates the same electronics package as standard Display Device as disclosed in the U.S. Patent Applications incorporated by reference above (without the display) and is preferably capable of driving any HDMI-connected display device to full 1080 p resolution. The Display Device Vision Plus has preferably the same processing, network, and context awareness capabilities as standard Display Device.

4. Display Device Software Player. the Display Device software player is preferably embedded into 3^{rd} party display devices to connect with the advertising platform service and deliver equivalent capabilities within performance limitation of 3^{rd} party hardware and operating system.

There are four categories of Display Surfaces based on their ownership and type of relationship with the Exchange and Advertising Platform of the present invention.

Out-of-Home (OOH) Display Surfaces designate all devices that are owned, managed and operated by out-of-home and outdoor advertising companies. The sole purpose of these display devices is to display Ad Campaign managed by the advertising platform system of the present invention. These display surfaces are registered with the advertising platform service either directly or through the Exchange.

Public Space displays (PSDs) preferably designate all Display Surfaces that are individually owned and operated by businesses and located in public spaces like restaurants or dentist offices for the purpose of displaying public information as well as ad content managed by the present invention system. These Display Surfaces are registered with the advertising platform service through the Exchange in return for revenue sharing opportunity.

Private displays (PDs) designate Display Surfaces owned and operated by private individuals and located in their private space (residence) for the primary purpose of presenting art, decor and entertainment visual (and audio) content. These Display Surfaces can be registered with the present invention service through the Exchange in return for ad-sponsored services; i.e., services that are discounted in return for the opportunity to interlace platform-driven advertising content through normal media content viewed on the Display Surface or the controlling user interface in the case of advice. The value of the sponsorship is based either on impression (i.e., viewing), conversion (i.e., action from viewer) or acquisition (i.e., purchase of advertised product).

Commercial Displays (CD) designate Display Surfaces owned and operated by companies in the broad hospitality industry and located in private spaces (e.g., room or suite) occupied by their customers for the primary purpose of allowing private users to present art, decor and entertainment visual (and audio) content. These Display Surfaces are registered with the advertising platform service through the Exchange in return for revenue sharing or ad-sponsored service opportunities. Platform-driven advertising media content is interlaced with normal media content on the Display Surface or the controlling user interface.

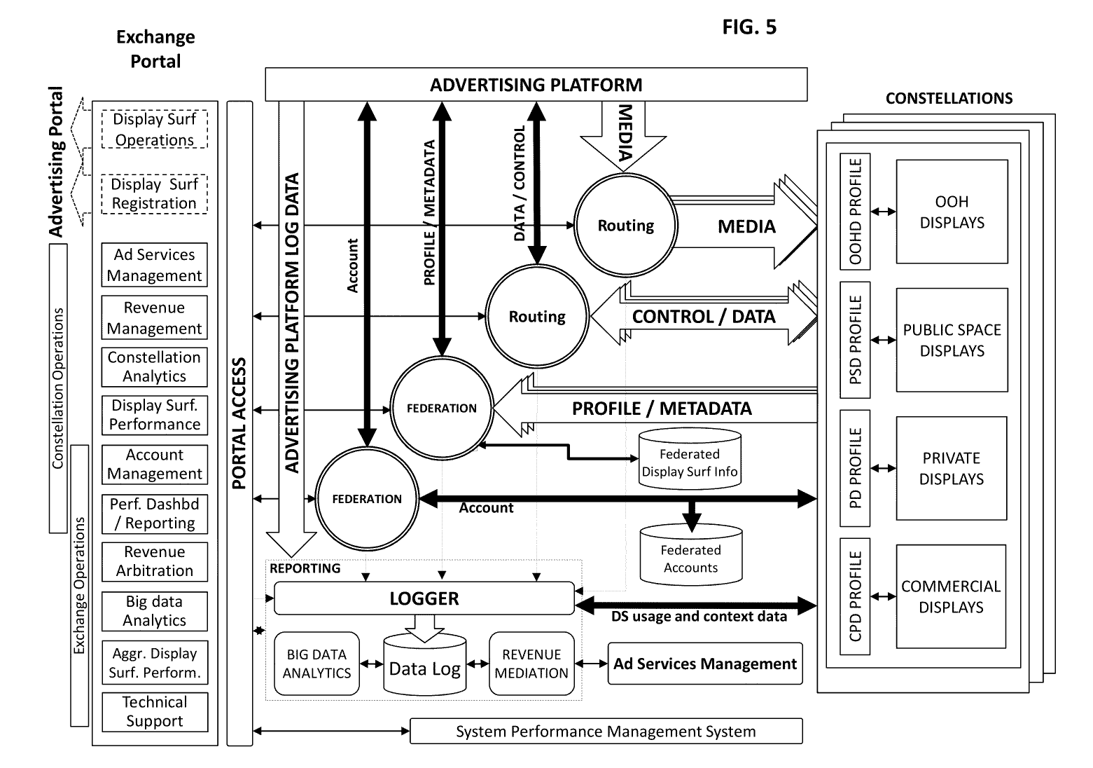

The Exchange system acts as a federation hub for the various Display Surfaces grouped as constellations and the advertising platform system, as seen in FIG. 5. Specifically it governs the flow of data and control information between the advertising platform and Display Surfaces to enforce a strict security framework and arbitrate revenue sharing between the various parties involved, i.e., the advertising platform, Constellation Operations, and Display Surface operators. The primary function of the Exchange is to federate all Displays Surfaces and users from various Constellations, secure and facilitate access to platform services and mediate and create an audit trace of shared revenue. The Exchange routes advertising media content and controls and commands to the various registered Display Surfaces and returns usage and status data from each active Display Surface to the advertising platform. It also federates static and dynamic profile and metadata information from Displays Surfaces as well as user account and profiles to be used by the platform. Exchange Logger function records and logs all information transiting through the Exchange including detailed fees and other usage and context data from each registered Display Surface. Logger also receives a copy of all relevant platform-logged information. Logger organizes this information in a database to be used by the analytics engine and revenue mediation function. A specific function of the Exchange (Fee Management) keeps track of usage and registration information to calculate and manage fee revenue sharing.

Once properly registered, the Exchange preferably ensures proper authentication of each Display Surface and secure delivery of advertising media content and controls, as well as usage, context and play out reporting data.

The Exchange also manages the flow of information between constellations, their Display Surfaces and the advertising platform:
Display Surfaces to/from Constellation
   Status and activity metrics
   Service management
Display Surfaces to/from the platform
   Status and activity metrics
   Service management
   Profile update
   Advertising media content
   Advertising media control
   Context and usage reporting
Constellation to/from the platform
   Registration information
   Revenue information
   Service management

The Exchange collects detailed usage and context information for each registered Display Surface and securely transmits a sub-set of this data to the advertising platform for its various processing functions. Exchange preferably keeps a log of all activity, usage and context metrics for performance analysis, audit and general “big data” analytics.

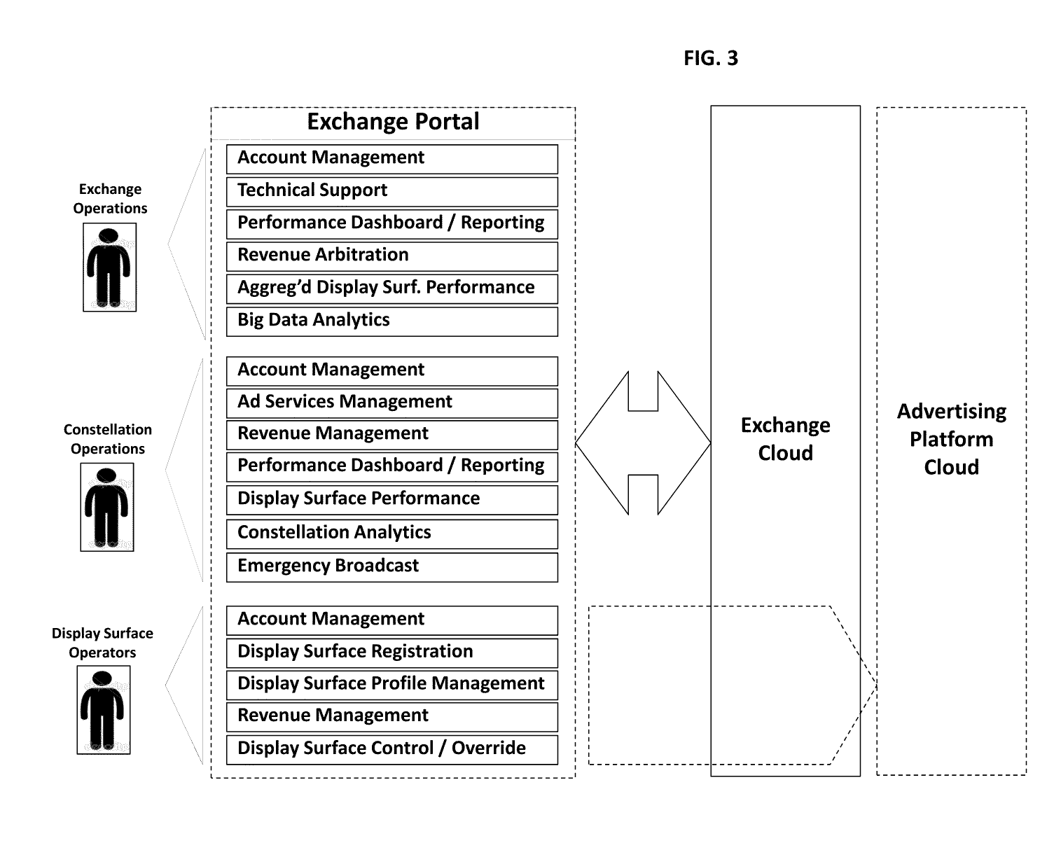

As seen in FIG. 3, the Exchange portal provides a comprehensive user interface to Exchange Operations, Constellation Operations and Display Surface Operator users. Each user preferably has an account with a profile that restricts access to data and functions to provide a secured operating environment. Display Surface Operators use an Exchange portal that is customized for their own constellations; although functionality and data is provided from the advertising platform, the customized Exchange portal shields user from the advertising platform and provides secured authentication and proper traceability to the Constellation.

The Exchange Portal serves two primary types of users: Exchange Operations and Constellation operations. The Exchange Portal preferably enforces strict login validation and authentication to deliver the all key functions including account management (profile and settings creation and management, usage history, support requests and financial information)

The Exchange Portal preferably delivers the following key functions to Exchange Operations:
Technical Support: alerts, monitoring, capacity planning, control/override, trouble ticket management and communication.

Performance dashboard and reporting: suite of real-time dashboards and reports to provide instantaneous or historical view of all key performance indicators and mine for more detailed information. A suite of tools is also available to define customized dashboard views and reports.

Revenue arbitration: tools to monitor trace and audit revenues sharing to constellations and individual Display Surface operators.
Aggregated Performance of Display Surfaces: tools to monitor, trace and audit Display Surface performance in aggregated groups to identify key trends.
Big Data Analytics: suite of analytics tools to perform usage, trend, cohort and other types of analysis to extract key market and usage indicators from all usage and contextual data collected from all Display Surfaces.
Account Management: A function for creating a user profile and credentials that are used to control access to functions, validate and authenticate inputs, and allow users to access system resources.

Constellation Operations is focused on controlling and managing platform revenue sharing, supporting onboarding, managing Display Surfaces (primarily performed by Display Surface Operators) and managing emergency situations.

The primary function of the Constellation Operations is managing a mechanism to push ad-sponsored services to end users or consumer of services delivered through a Private Display or Commercial Display:
For Private Display owners (and Operators) subscribing to this mechanism, they preferably receive a discount on services delivered through their PD or purchases driven through their PD.
For Commercial Display owners (and Operators) subscribing, they preferably receive a discount on services delivered through their PD, purchases driven through their PD or credits against future services related to their PDs. Discount and credits can also be shared with their own customers.

The Exchange Portal delivers these other key functions to Constellation Operations:
Revenue Management: tools to monitor and audit shared revenue from the advertising platform at an aggregated level for the Constellation, groups of Display Surfaces or individual Display Surfaces. A revenue engine preferably keeps track of downstream revenue sharing and provides detailed revenue records to Constellation Operations.
Performance Dashboard and Reporting: tools to monitor aggregated performance of Display Surfaces in real-time or review historical performance. A suite of tools is also available to define customized dashboard views and reports.
Display Surface Performance: tools to monitor performance of individual or group of Display Surfaces in real-time or review historical performance. A suite of tools is also available to define customized dashboard views and reports.
Constellation Analytics: suite of analytics tools to perform usage, trend, cohort and other types of analysis from all usage and contextual data collected from all Display Surfaces.
Emergency Broadcast: Constellation Operations is also capable of using its registered Display Surface for emergency broadcast through override control. An emergency broadcast is a special type of media content that overrides any other advertising content in case of emergency. The Advertising Portal allows Constellation Operations to predefine a series of advertising media content (using the automated workflow) that can be pushed to any Display Surface or grouping of on a moments notice, thus overriding any scheduled ad placement during that period.
Account Management
Ad-Sponsored Services Management: A mechanism to push ad-sponsored services to end users or consumer of services delivered through a Private Display or Commercial Display:

Display Surface Operators use a portal that is customized for their Constellation to access the various functions needed to manage participation to the advertising platform. This portal is primarily managed by the Exchange that uses functions provided by the advertising platform.

Supporting of Display Surfaces onboarding and management is preferably performed through the same set of tools used by Display Surface Operators in read-only mode unless the Display Surface Operators has explicitly delegated or authorized Constellation Operator to create and edit Display Surface registration and profile information.

The primary purpose of the Exchange is to federate all Constellation Display Surfaces and provide secure access to external cloud services such as the advertising platform. In doing so, a large amount of information pertaining to operations and context of Display Surfaces transits through the Exchange, thus making it the ideal location to collect and store data for “big data” analytics applications.

The Exchange infrastructure, as seen in FIG. 5, is designed to authenticate, secure and re-direct or route data streams from Constellations Display Surfaces to/from the advertising platform (or other external cloud services):

1. Routing advertising media content: Advertising media content is distributed to targeted Display Surface through the Exchange. The Exchange authenticates media content, route it to proper Display Surface and provides acknowledgement to the advertising platform.

2. Routing data and control: The Exchange authenticates all platform controls to Display Surfaces and provides acknowledgement to the platform. The Exchange also authenticates all play out data from Display Services and route this information to the Advertising Platform. Play out data is standard industry report presenting all key statistics related to execution of an advertising campaign.

3. Federating Display Surfaces registration, profile dynamic status and metadata: The Exchange authenticates and validates all Display Surface information pertaining to registration, static and dynamic profile information as well as all other platform performance data. This information is aggregated and normalized—i.e., information is put in the same format and structure to make it easier to pass onto the Advertising Platform—and transmitted to the platform while protecting privacy of individual Display Surfaces.

4. Federating user access: The Exchange handles all authentication and credentials from Display Surfaces and their operators and sends aggregated and normalized information to the Advertising Platform while protecting privacy of individuals.

5. Aggregating logged data: Platform-logged information is rolled up in the Exchange and aggregated with usage and performance data from media routing, control and data routing, Display Surface federation and user account federation.

6. Aggregating Display Surface usage and context data: Detailed usage and contextual data is captured by the Exchange conditional to permissions and profile of each Display Devices. This information is correlated with all other information transiting through the Exchange (#5 above).

7. Managing ad-sponsored services and revenue sharing: The Exchange receives revenue sharing and underlying advertising results information for the platform to validate performance metrics and arbitrate revenue distribution to each Constellation and/or individual or group of Display Surfaces.

The platform of the present invention allows a buyer of display time (i.e., Advertiser buying Viewing Slot on Display Surfaces) to create, manage and monitor an advertising campaign using a simple 5-step workflow:

1. Create advertising media content

2. Create Advertising Campaign

3. Find Display Surfaces

4. Acquire Display Surface Viewing Slots

5. Manage Advertising Campaign

The two main components of the platform are a portal delivering a user interface to perform various functions and software infrastructure hosted on a cloud infrastructure to maximize service availability, scalability and enforce a strict security framework.

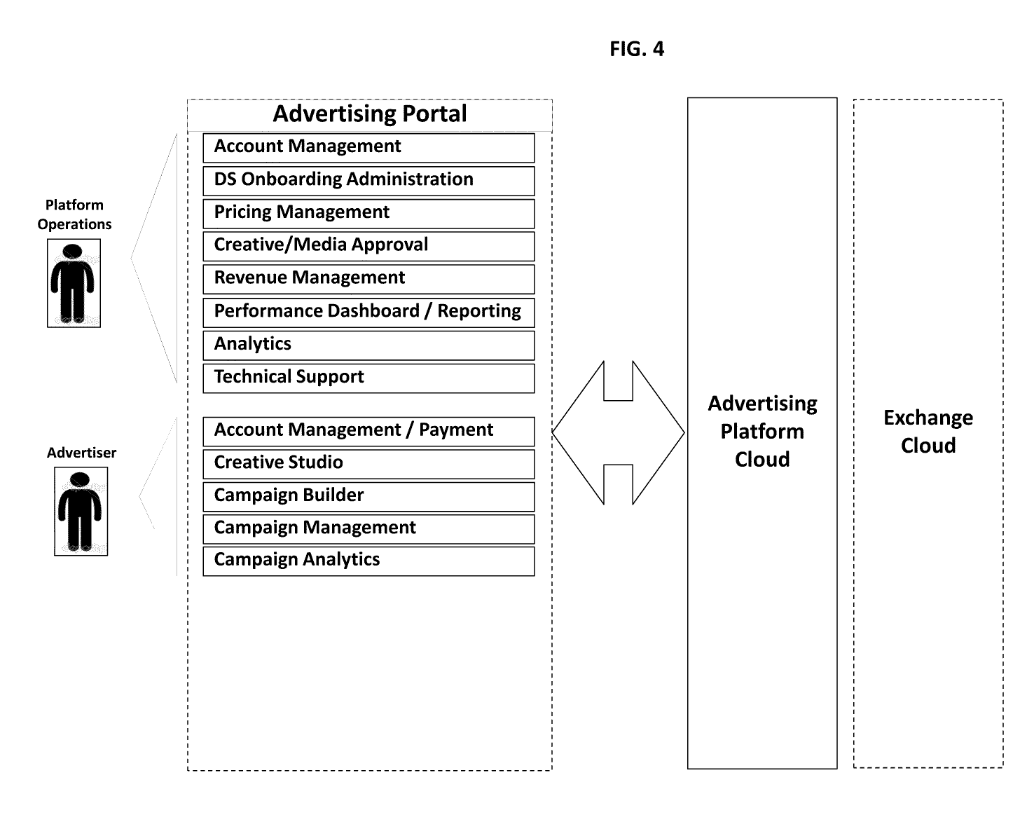

As seen in FIG. 4, the advertising portal of the present invention provides a comprehensive user interface to Advertising Portal Operations and Advertiser types of users. Each user has an account with a profile that restricts access to data and functions to provide a secured operating environment.

Advertisers, Display Surface Operator, Constellation Operator and platform operations access various Views of the advertising portal to manage their respective functions and services. The role-based authentication offers each group the following abilities:

1. Advertisers register and ingest/create advertising media, create and manage campaigns, monitor dashboard, report and analytics and manage payments and their account from the advertising portal. Live chat support is offered to deliver timely problem resolution and maximize user satisfaction.

2. Display Surface Operators register, register Display Surfaces, manage Display Surface profiles, manage participation schedule, monitor dashboard, report and analytics and manage revenue and their account from the advertising portal. They also preferably manage their own media content and viewing campaign on their own Display Surfaces when these Display Surfaces are off of the advertising platform, i.e., when the platform does not control the advertising content displayed on these Display Surfaces. Login validation and authentication of Display Surface Operators is actually performed through the Exchange portal; once completed user is tunneled to the advertising portal while maintaining authentication through the Exchange portal.

3. Constellation Operator register, manage their participation to the advertising service, monitor performance of their Display Surfaces and manage their revenue and account from the advertising portal. Similarly to Display Surface Operators, Login validation and authentication of Constellation operations is actually performed through the Exchange portal; once completed user is tunneled to the advertising portal while maintaining authentication through the Exchange portal. In most cases, Display Surface Operator and Constellation Operator privileges are shared by same users.

4. Advertising Platform Operations interacts with the advertising portal to support all users and ensure availability and peak performance operations of the platform. In addition, Advertising Operations uses the Advertising Portal to manage the Display Surface registration workflow and advertising media content approval workflow, administrate inventory and pricing and deliver chat support to all users.

User registration and authentication is performed by the advertising platform in collaboration with the Exchange for Constellation and Display Surface operators. Once the user registration process is completed, an account is created with unique credentials that are authenticated at each login time. In addition, the actual computing platform (tablet, laptop or desktop computer) used to access the advertising platform (and Exchange) service is also preferably authenticated with an access code. Once fully registered, a log of all actions and data is kept for each individual user.

All participating Display Surfaces preferably go through a registration process to join the advertising platform service. The registration process is performed through the advertising portal via the Display Surface operator account. The registration process is driven by a wizard that guides the user through a series of specific questions and automated data capture in order to create a complete description of the Display Surface. The registration process includes image upload of the establishment/location, definition of Display Surface identification and characteristics and definition of the participation schedule(if applicable).

The operator of a Display Surface can determine a static or dynamic media content rating “opt out” to prevent inappropriate or undesirable advertising media content to be viewed on a registered Display Surface (e.g., McDonald's ads in a Burger King). Static media rating is enforced at all time while dynamic content rating is evaluated in real-time based on pre-defined rules and data sources.

The submitted registration is reviewed in detail by advertising operations before the Display Surface is added to a Constellation.

Operators of Public Space Displays (PSD) are also able to define time periods during which the PSD is available to display platform-driven advertising content. Operators are preferably able to override this schedule to adapt to last minutes changes. Finally, a data capture “opt-out” is defined for each Display Surface. This data capture opt-out limits or prevents collection of usage or contextual (e.g., device proximity, person proximity or absence) data by the Exchange. Depending on type of Display Surface and subscribed cloud services, the Constellation may impose or offer limited options ranging from complete delegation to individual user or owner/operator to complete imposition. Similarly, Constellation or individual user or owner/operator may also have the option to set advertising preferences to prevent or encourage certain types of advertising media content.

Once an Advertiser account is created and funded, the Advertising Portal manages an end-to-end workflow that streamlines and automates the steps for (1) creating advertising media content using the automated workflow, (2) creating an Advertising Campaign, (3) finding adequate Display Surfaces, (4) acquiring Display Surfaces Viewing Slots, and (5) managing advertising campaigns.

Advertisers ingest or create advertising media content via the automated workflow aspect of the present invention. There are two primary types of advertising media content: (1) traditional audio/visual media content such as still pictures and video/audio and (2) advertising apps, that are running in Display Surfaces tethered to the advertising platform back-end.

Media can be uploaded to the advertising platform cloud in its original format via the automated workflow wizard and user selects and defines its target Display Surface profile. Once uploaded, the aspect ratio of the original media content is normalized, its resolution, contrast and color depth are adapted to the selected Display Surface profile to obtain maximum visual quality. The adapted original media is then transcoded to internal mezzanine format and its display attributes are once more optimized to deliver maximum viewing experience on the selected Display Surface profile. The internal mezzanine format is the internal format for storage of media content, and is fully described in U.S. patent application Ser. Nos. 14/213,729, 14/213,773, 14/213,810, 14/213,873, 14/213,918, 14/213,956, 14/213,981, and 14/214,017, the applications incorporated by reference above.

Key visual elements are preferably automatically detected and visual content optimizations such as framing, cropping or off-setting are suggested to user. Derivative content objects (thumbnails, previews, watermarked previews) can then be generated and all visual objects (original, mezzanine format and derivatives) are registered with a Digital Right Management system to ensure proper security, authenticity, privacy and usage tracking. The process is gated with a series of checkpoints where user can validate resulting objects or select options.

The automated workflow provides tools to overlay tags on top of ingested media content to allow for visual information to be overlaid in real-time when the visual content is pushed to the Display Surface. User defines (1) a regular geometric shape (tag shape) on top of the ingested media content, (2) the visual information that will be super-impressed at viewing time, (3) the visual attributes of the tag shape (color, border, transparency and texture), (4) the type of the tag object (text, QR code or image) and the real-time source of the tag object (time, data feed, RSS feed, etc.). For example, the message “Take a picture and send it to www.whateverXYZ.com to win!” can be overlaid on top of a poster and “XYZ” can be changed in real-time to reflect time or location.

Ingested content may also include an audio channel that will also be normalized and transcoded to a mezzanine format. Normalization process preferably includes sound level adjustments, frequency normalization and enhancements and re-sync with visual content. Content metadata is also captured during the process. In addition to standard content metadata defining the technical specifications of the content (orientation, aspect ratio, resolution, etc.) that is preferably automatically detected by the ingestion engine, additional attributes such as audience rating, key visual elements, optimum viewing conditions and visual DNA classifications are also requested from the user.

The ingestion workflow is preferably asynchronous to allow several individuals to collaborate in a non real-time process. The final set of objects (content and metadata) is reviewed by Platform Operations creative specialists and by Advertiser and digitally signed for approval. A non real-time process is one in which all users do not need to participate at the same time.

Dynamic Composite advertising content can be rendered in real-time on most Display Surface types. The automated workflow is used to create such graphics animation content using a combination of elementary visual objects (audio channel, graphics animation, static text, crawling text, tiles, rotating surface, moving surface, etc.), display layouts(right L-shape, vertical pillars, n-row, etc.), and ingested media content (images and video/audio clips) controlled by a playlist or driven from an external data source (time, data feed, RSS feed, etc.). It also allows users with special privileges to create customized objects, layouts and external data sources.

A special type of template and playlist combination allows coordination or collaboration of visual content across several Display Surfaces. For example, a series of animated graphics content could playback on several Display Surfaces around a food court with start and key scene transitions synchronized across all Display Surfaces.

The sequencing and timing of dynamic composite content can be configured to adjust automatically to traffic conditions to maximize the experience for the viewing audience. Using data sources such as Google traffic or connected sensors such as a Doppler radar, Display Surfaces can automatically sense traffic conditions and adjust viewing Program Block and Viewing Slot duration accordingly. Similar adaptive media content execution is possible based on weather conditions or other defined data sources.

The concept of Advertising Application is unique to the advertising platform of the present invention. The back-end design of the platform in combination with unique capabilities of the Display Surfaces as disclosed in U.S. patent application Ser. No. 14/213,729, all incorporated herein by reference, enables use of apps to drive media content on each Display Surface or coordinated across several Display surfaces and interact with the ad placement process The Applications are preferably Android-based applications developed by approved third party developers to run on Display Surfaces in a processing environment. The Applications are developed using an extended version of the automated workflow that incorporates a Software Development Kit (SDK). The Software Development Kit is a suite of software tools used to write software for a specific operating environment. The SDK is fully described in U.S. patent application Ser. Nos. 14/213,729, 14/213,773, 14/213,810, 14/213,873, 14/213,918, 14/213,956, 14/213,981, and 14/214,017, the applications incorporated by reference above.

Applications are automatically installed on the selected Display Surfaces when the advertising campaign is scheduled to execute and is responsible for generating the visual and audio content that will be viewed on that Display Surface, thus enabling an unequaled degree of autonomous operations, localization, interaction, coordination and adaptation to the local environment. Applications also coordinate their actions with collaborating Display Surfaces or provide data to the advertising platform that may affect the outcome of the bidding process. Applications uses the resources provided by the Display Surface operating system (VOS) to gather information and commands and generate visual (and audio) content accordingly. Using that mechanism, Applications can process four types of input to generate its visual content:

1. Local Display Surface parameters such as time, temperature, etc. . . .

2. Network Data Feed coming from the platform cloud including commercial RSS feed, XML feed, private data feed (from an external 3^{rd} party private or private cloud), URLs or any ingested media content.

3. Local sensor data feed from sensor communicating data directly to the Display Surface through its USB, Ethernet, BTLE or WiFi connectivity.

4. Other Display Surfaces including their own direct sensor data feeds.

Once developed and tested, Applications are published in a catalogue such as the App Store where they become available to be used in an advertising campaign. Advertising media content of all types are capable of being published to catalogues and made available to other Advertisers for a predetermined price. All published content available through an App location Store is pre-approved by platform operations.

As seen in FIG. 8, the Applications preferably take advantage of the services provided by V-Operating System of the Display Surfaces disclosed in the U.S. Patent Applications incorporated by reference above to compute the image, sound and actions to be rendered or produced by a Display Device. VOS provides access to a large number of services including input data streams from (1) embedded sensors (e.g., orientation or GPS), (2) remotely connected sensors or data sources, (3) data from collaborating Display Surfaces, (4) data sources from the platform cloud and (5) data sources from external cloud services and routed through the platform cloud. All image, sound and actions produced by a Display Device can be logged in the platform cloud.

The automated workflow enforces a strict security framework on the Applications. Applications can be authenticated and digitally signed when published. They are downloaded to the Display Surface processor using a secure transfer protocol using 256-bit Advanced Encryption Standard (AES) encryption. Applications are authenticated before being installed on the Display Surface and digital signature is validated each time it is loaded to execution. This security framework is supported by the security architecture of the Display Devices which includes a secured lock-down processor with a secure booth loader, a signed Android OS running on a secured partition, and security key registers that are not exposed in clear outside of a trusted application space.

The SDK provides resources to integrate Applications to the advertising platform reporting and Operations monitoring. Through this SDK, the Application developer can add metrics that are specific to the Application to the standard reporting and operations tools available through the Advertising Portal.

The Campaign Builder tool allows an Advertiser with appropriate privilege to (1) create an Advertising Campaign, (2) identify targeted Display Surfaces and (3) acquire Viewing Slots. Campaign Builder uses an automated workflow to guide Advertiser through this definition and approval process.

The first step of building an Advertising Campaign requires definition of key parameters including:

1. Author, title, merchant, product category and targeted audience

2. Content and ratings

3. Financial governance: Campaign budget, daily budget, maximum bid and average bid

Then Advertiser can link its advertising media content to the Campaign definition. The metadata of the advertising media content is used in the selection of compatible Display Surfaces and acquisition of Viewing Slots.

Once the definition of an Advertising Campaign is completed, it is submitted for approval and other external approvals defined by the Advertiser. The Advertiser completes the Advertising Campaign design process by “arming” the campaign, i.e., loading the Advertising Campaign in the Logic Engine of the Advertising Platform to be evaluated when the selected time cycle is processed.

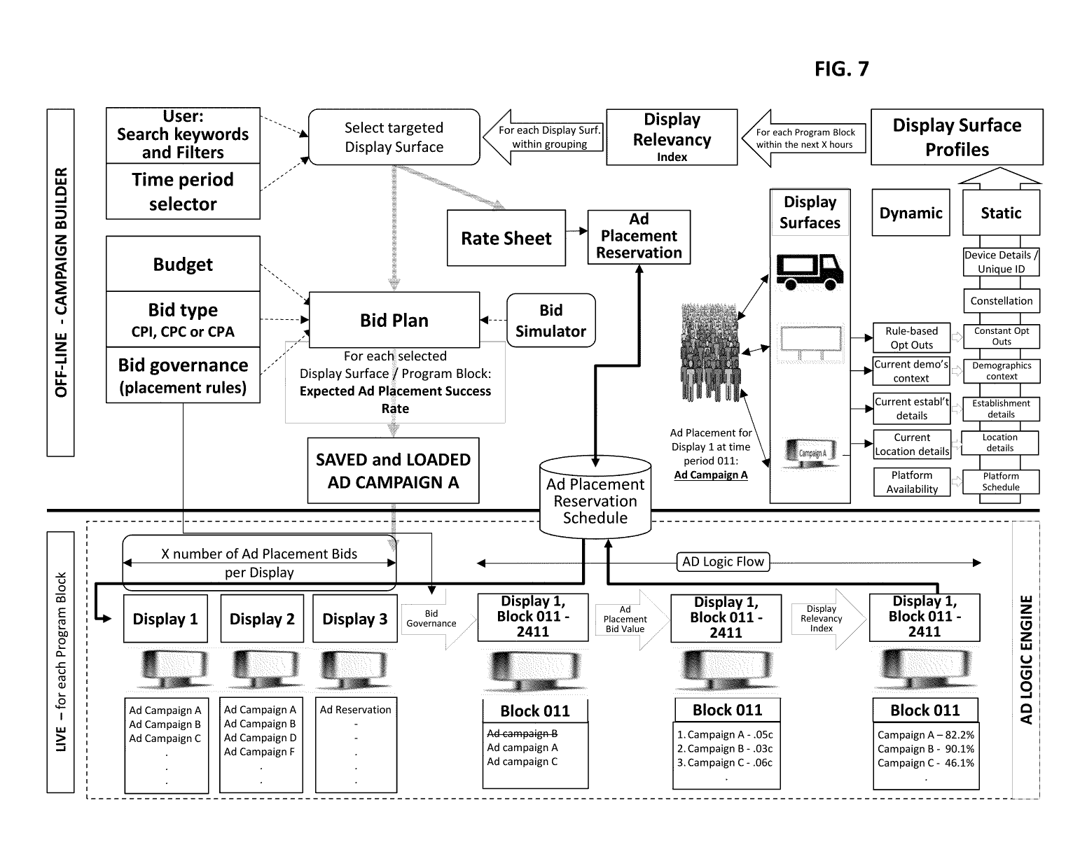

As seen in FIG. 7, the internal Ad Logic flow is divided into an off-line process performed through the Campaign Builder user interface and real-time bid/buy evaluation process resulting in allocating advertising media content to each Viewing Slot of each Program Block for each active Display Surface. Advertisers use Campaign Builder to define the parameters of the campaign and identify the most relevant Display Surfaces using a search engine and the Display Relevancy index calculated using static and near real-time profile attributes of the Display Surfaces. Advertising campaign parameters (including bid type, bid governance rules and budget information) and targeted Display Surfaces are combined into a Bid Plan and armed to be evaluated by the logic engine when the targeted Program Block is approaching. Alternately, an advertising plan may use a fixed rate-sheet process to immediately purchase a Viewing Slot in a Program Block in which case the transaction is preferably immediately processed and the Viewing Slot is allocated to the advertising campaign. In real-time, at a pre-determined period of time ahead of each Program Block, the bid logic engine evaluates Bid Plans and selects the winning advertising campaigns that will obtain a Viewing Slot in the Program Block. The Ad Logic Engine then passes the ad placement list for that Program Block and Display Surfaces to the Ad Controller sub-system.

The last step of defining an advertising campaign once Viewing Slots are acquired or campaign bid is armed, then Advertiser links its advertising media content to the campaign.

Advertisers use free-text keyword searches and filters(location, Display Surface types and attributes such as resolution, orientation, fix/mobile, indoor/outdoor, content restrictions, etc.) to generate a list of Display Surfaces that best match the ad placement criteria for specified time periods—Program Blocks ranked as “must”, “nice to have” or “excluded” as well as blocked periods and viewing frequency—and ranked using their Ad Relevancy score. The Advertiser can browse these Display Surfaces, review their profile and select groups of or individual Display Surfaces. The Display Surface Finder also recommends other Display Surfaces or groups of that would meet campaign need.

Availability of each Display Surfaces for displaying platform-driven advertising content is divided into Program Blocks that represent time slices within which a number of advertising “Viewing Slots” are displayed for a fixed duration of time. By default, a Program Block is defined at 5 minutes and each Viewing Slot has duration of 30 seconds. These parameters are defined as part of the Display Surface profile. Viewing Slots are acquired using one of two models: (1) using the traditional fixed Rate Sheet model or (2) using a real-time bidding model.

The Rate Sheet Process of the present invention offers an Advertiser a fixed guaranteed purchase price for a standard Viewing Slot on a specific Display Surface. The price is either pre-negotiated between the platform and the advertiser or pre-determined based on historical and current market conditions. The advertising platform also offers the possibility to algorithmically determine a rate sheet using historical bid/rate prices, seasonal/locational factors, current bids, length of campaign, and time value left before start of schedule defined.

Special pricing conditions may be offered for Viewing Slots of various duration or higher ad placement frequency within a Program Block. A purchase converts to an ad placement reservation and blocks the time slot on the Display Surface for the duration specified.

The bidding process of the present invention is a bid model where Advertisers seek Display Surface Viewing Slots that meet their advertising Campaign objectives by defining bid parameters and governance rules. The winning campaign bid converts to an ad placement reservation and blocks the time slot (Viewing Slot) on the Display Surface for the specified duration.

The bidding process is preferably based on one of three pricing model:

1. CPI—Cost per Impression: Campaign results and cost to Advertiser are measured in terms of estimated number of eyeballs with no tangible feedback. Estimated number of eyeballs is either based on historical or official demographics and crowd data or using real-time audience monitoring data.

2. CPC—Cost per Click: Campaign results and cost to Advertiser are measured in terms of viewers that have acted as a result of experiencing the platform-driven advertising media content. User actions can range from calling a specific phone number to scanning a QR code or sending a picture of the advertising media to an email address.

3. CPA—Cost per Acquisition: Campaign results and cost to Advertiser are measured in terms of viewers that have made a purchase as a result of experiencing the platform-driven advertising media content.

The Advertiser can select a bid type (CPI, CPC or CPA) and define a bid plan (minimum bid, maximum bid, daily budget limits and conditions) and governance, i.e., a set of rules controlling ad placement with respect to its context (e.g., not on cold days, not after campaign XYZ or not after X Rating ad). The bids are evaluated in real-time by the Logic Engine to determine the winning bid for each Viewing Slot or each Program Block of each Display Surface in order to maximize revenue for the advertising platform. The Logic Engine takes into consideration the static profile of the selected Display Surfaces as well as dynamic factors that are provided in real-time by Display Surfaces' VOS. Data provided by apps running on Display Surfaces is also considered.

The Bid Simulator is used by Advertisers to evaluate the potential results of a bid. Bid Simulator uses campaign and bid parameters, selected Display Surfaces, targeted Program Blocks and historical data to calculate the expected Ad Value based on historical data and provide a quantified indication of the expected results of the advertising campaign.

Advertisers use a series of tools available through the Advertising Portal to monitor and control their Advertising Campaign in real-time once it is armed.

The dashboard function is used by Advertiser to monitor and control in real-time the progression of a campaign or multiple campaigns in terms of running costs as well as actual versus budget, bid parameters compared to bid wins, actual captured display devices and display device attributes. The dashboard function also performs continuous forecast extrapolations based on historical and current data to provide an estimate of campaign results. The dashboard also provides controls to pause or terminate the campaign globally or on a Display Surface or Program Block basis.

Dashboard data is presented in a set of views that an Advertiser can adapt to its needs through configuration tools. All monitoring data is captured and stored by the LOGGER function. The Advertiser Dashboard is also used to produce reports of some key parameters including:
Play out report per Display Surface, grouping of or globally
Timing and context of each Program Block
Estimated or actual results (CPI, CPC or CPA) per time period, Display Surface, grouping of Display Surface or Program Block
Cost over time

Each media asset and each advertiser will accrue a detailed log of what played, when, and its related costs.

Advertisers can also use a report customization tool to produce customized reports. Reports are exported in standard file formats.

A play out report is a report that preferably lists every occurrence of a commercial on a specific channel or station, and in the context of the present invention refers to a report that lists each display of a specific ad campaign on the display device controlled by the Advertising Platform of the present invention.

The Analytics function of the present invention uses an extensive data captured by the Logger function to generate reports, perform correlation, trend and cohort analysis and correlation analysis. Results are viewed through web pages and can be exported in standard file formats.

Advertisers use the Account Management function available through the Advertising Portal to manage their profile and settings including:
ID summary
Authorized access devices
Purchase and activity history
Alerts

A very important element of Advertiser account is the payment information which is used in the design and execution of Advertising Campaigns to set limits or control spending.

The Display Surface Operator view provides access to all data pertaining to performance and status of a specific Display Surface or grouping of Display Surfaces including real-time view of displayed advertising media content, current status of the Display Surface operating conditions, historical technical performance metrics and platform performance metrics. It also provides a number of controls to affect the operations of a Display Surface in real-time including media pause, terminates, restart, stop and re-start and embedded processor stop and re-start. The Display Surface Operator also uses the Advertising Portal to manage its account and settings including review of revenue history and revenue sharing parameters.

Platform Operations is responsible for ensuring customer experience, supporting registration and content workflows, and continuous peak performance operations of all components of the platform systems from content ingestion to Display Surfaces and Advertiser reporting and analytics. The Advertising Portal preferably supports at least the following Operations functions:

1. Onboarding Administrator: Review and oversee asset registration workflow. Validate all asset registration data before it goes live into active inventory. Manage any custom demographic metatags that should be applied to assets

2. TechOps: Proactively Monitor and Optimize platform infrastructure and displays. Reachable in live chat from the portal.

3. Pricing Administrator: Review and manage display asset pricing optimization. Review and oversee rate sheets and bidding algorithm and process fidelity. Able to override if warranted.

4. Creative Collaborator/Approver: Assist Advertisers in designing Ads which meet their objectives. Review, validate, and approve submitted Ads for live usage. Reachable in live chat from the portal.

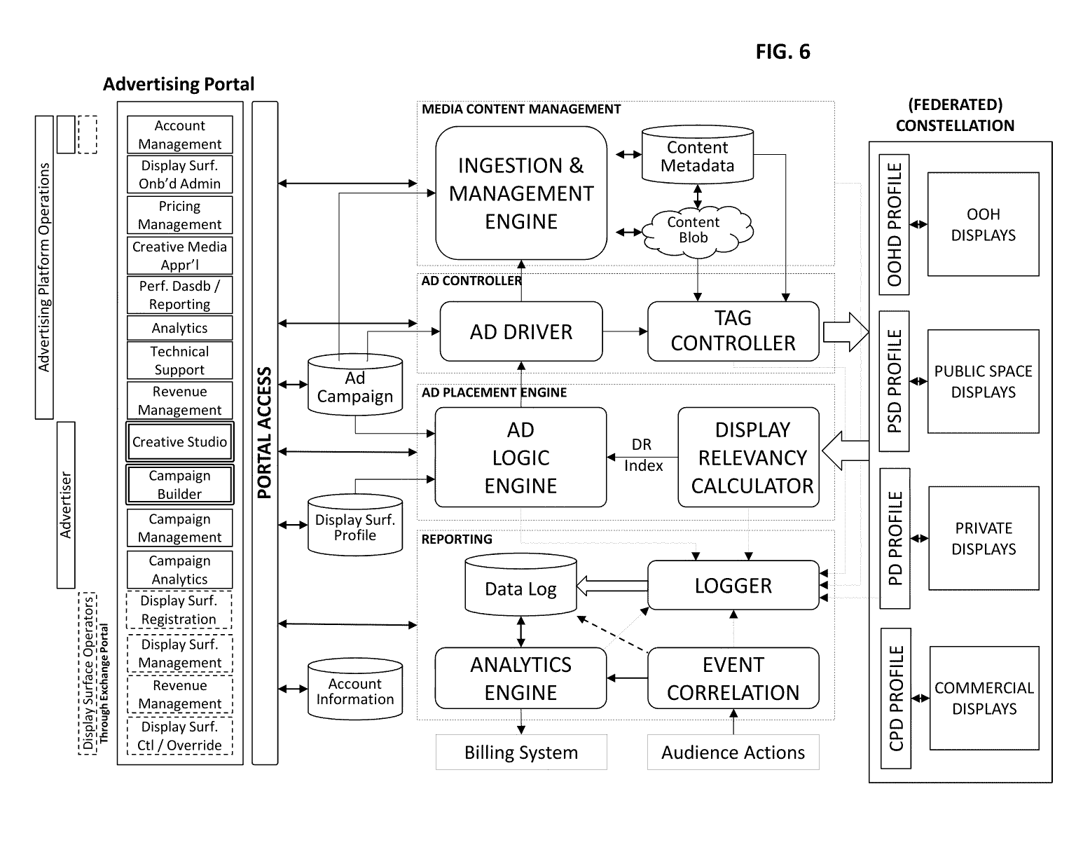

As seen in FIG. 6, the advertising platform of the present invention preferably delivers four main functionalities: Media Content Management, Advertisement Control, Advertisement Placement and Reporting. The automated workflow user interface is used to create and manage advertising media content that is processed and stored through the Media Content Management sub-system. The Campaign Builder user interface is used to define all parameters and attributes of an advertising campaign in order to acquire Viewing Slots through the Rate Sheet or bidding mechanisms. The Ad Logic Engine processes advertising campaign information along with the Display Relevancy index of targeted Display Surfaces to allocate campaigns to Display Surfaces for each Program Block. The Advertising Controller receives the advertising placement information from the Ad Logic engine, fetches the advertising media content from the Media Content Management system and transfers all data to the Tag Controller that inserts preferably real-time tags to customize media content for each targeted Display Surface. The data Logger captures all real-time and non real-time information, adds time tags and other indexing metadata and stores all logged information in a database used by the analytics engine. Also the Event Correlation function correlates data resulting from audience actions in reaction to “experiencing” advertising media content with advertising campaign to track and calculate CPC and CPA results.

The Advertising Platform infrastructure is made of a suite of servers hosted on a mission critical cloud infrastructure:

1. Media Content Management

2. Advertising Controller

3. Ad Placement Engine

4. User Reporting

5. Account Management

6. System Performance Management

These servers are designed for high service availability and scalability using state of the art software architecture and implementation techniques.

The Media Content Management (MCM) sub-system handles media content ingestion and delivers all back-end functions delivered through the automated work flow including:

1. Content upload

2. Content normalization and adaptation

3. Transcoding and derivatives

4. Watermarking

5. DRM

6. Apps compliance and validation

MCM communicates with the Advertising Portal through secured HTTPS while all media content is encrypted with AES-256. Higher level of content security is also envisaged (separate patent filing). Original media content and mezzanine format are stored in separate Blobs while derivative formats and metadata is stored in a separate NOSQL database. Original media content and mezzanine format are fully DRM'd. All media content and metadata is encrypted (AES 256) for storage. The storage of content and normalization of content into a standardized format that is more easily managed are fully described in U.S. patent application Ser. Nos. 14/213,729, 14/213,773, 14/213,810, 14/213,873, 14/213,918, 14/213,956, 14/213,981, and 14/214,017, the applications incorporated by reference above.

The Ad Controller sub-system drives Display Surfaces based on Ad Placement results. The Ad Driver retrieves advertising media content from the ingested content blob based on Ad Placement results from the Ad Placement Engine and sends it to the Tag Controller. A log of all activities is captured by the Logger function.

The Tag Controller function receives the advertising media content from the Ad Driver and inserts tags and other unique information—visual or other. The Tag Controller packages all advertising media content and distributes it to targeted Display Surfaces. Tags and unique information can be a specific phone number, URL or QR code, or graphics that preferably makes each displayed content unique. They are used by the Event Correlation function to calculate the actual results of a campaign. For example, the results of a CPC campaign would be calculated by correlating consumer actions incorporating a specific tag with the Display Surface using that tag.

The Ad Placement Engine performs all processing leading to allocation of a specific advertising campaign media content to specific Display Surface View Cycles.

Each display has X number of Bids via campaigns or an Ad Placement Reservation (Buy it now) per Program Block. The Logic Engine will calculate an Ad Placement list for X hours (which is cached for offline mode) using real-time data per display. Display Relevancy is factored to optimize the CPI, CPC and CPA revenue when applicable. The governance, bid and Display Relevancy together determine the best qualified Ad placement score amongst the X number of Ad Placement bids per play block.

For each Program Block within the next X hours, Dynamic Profile values will be overlaid on Static Profile values to create the “current” Display Profile which is used to calculate Display Relevancy Index. The Index is calculated by using the Display Surface Finder inputs as search criteria across all Display Profiles. Each profile attribute match will carry a score. The profile attributes will have dynamically weighted scores in correlation to determinable search criteria importance, when multiple attributes achieve a search criteria goal, or when similar but not direct matching attributes are found. The profile's attribute scores will be totaled to determine the Display Relevancy Index

The Reporting sub-system incorporates all back-end components supporting production of timely and accurate reports, driving real-time dashboards and feeding analytics tools. The Logger function captures and time-tags all data generated by the present invention system including:

1. Ad Placement Engine results as well as intermediate data;

2. Tags and unique information correlated with targeted Display Surface;

3. Actual content display metrics reported by the display device;

4. All data feeds and sensor data used by Apps;

5. Audience actions with actual data reported or dash boarded;

6. Key Performance Indicators and alerts monitored by Platform Operations;

All data is preferably captured and indexed in real-time in a high availability SQL database with attached secondary long-term storage.

The Analytics engine is used by the Reporting and Dashboard functions to perform analysis of data captured by the Logger. A critical function of the Analytics engine is to calculate CPI, CPC and CPA result metrics and collect substantiating data that will be used by the billing engine. The Event Correlation Engine (ECE) preferably receives audience data, feedback and actions and associates and correlates with unique tags or other tracing mechanisms. This correlated data is used by the Analytics engine to calculate CPI, CPC and CPA result metrics.

The Account Management sub-system preferably performs all tasks related to creation and management of user accounts including login validation, access control and authentication, activity tracking and secured payment processing through payment gateway.

System Performance Management preferably collects and processes all system performance indicators and alerts required by Platform Operations. It includes as a minimum:
Performance metrics of each infrastructure sub-system;
Performance metrics and status of each active Display Surface;
Customer support chat;
Knowledge base;
Customer support trouble ticket management.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. A digital advertising system for displaying and optimizing revenue of at least one advertisement having bidding and rating information comprising:
at least one display device having a processor, a memory, and a profile containing attributes of the at least one display device;
an advertising platform adapted to receive said bidding and rating information associated with said at least one advertisement and to use said profile and said bidding and rating information to determine the placement of said at least one advertisement on said at least one display device; and
an exchange adapted to securely access said advertising platform and the at least one display device to govern the flow of data and control between the advertising platform and said at least one display device.

2. A digital advertising system as claimed in claim 1 wherein said advertising platform is dis-intermediated.

3. A digital advertising system as claimed in claim 1 wherein said advertising platform is configured to continuously reflect the latest status, conditions, and changes of the system.

4. A digital advertising system as claimed in claim 1 wherein said advertising platform can determine the placement of said at least one advertisement on said at least one display device in near real time.

5. A digital advertising system as claimed in claim 1 wherein said advertising platform is further configured to create and ingest advertising media content.

6. A digital advertising system as claimed in claim 1 wherein said advertising platform is further configured to optimize said at least one advertisement on said at least one display device.

7. A digital advertising system as claimed in claim 1 wherein said at least one display device is further configured to track usage of the at least one display device.

8. A digital advertising system as claimed in claim 1 further having at least one user which interacts with said system, wherein said interactions are controlled by profile, settings, and privileges associated with an account types of said at least one user

9. A digital advertising system as claimed in claim 1 wherein said advertising platform is an external cloud service.

10. A digital advertising system as claimed in claim 1 wherein said at least one display device is further adapted to have an advertising application automatically installed when said at least one advertisement is placed on said at least one display device.

11. A method for displaying and optimizing revenue of at least one digital advertisement having bidding and rating information comprising:
providing at least one display device having a processor, a memory, and a profile containing attributes of the at least one display device;
receiving by an advertising platform said bidding and rating information of said at least one advertisement;
determining by said advertising platform the placement of said at least one advertisement on said at least one display device using said profile and said bidding and rating information of said at least one advertisement;
securely accessing by an exchange information from said advertising platform and said at least one display device;
governing the flow of data and control between said advertising platform and said at least one display device by said exchange; and
displaying said at least one advertisement on said at least one display device.

12. A digital advertising method as claimed in claim 11 wherein said advertising platform is dis-intermediated.

13. A digital advertising method as claimed in claim 11 wherein said advertising platform continuously reflects the latest status, conditions, and changes of the system.

14. A digital advertising method as claimed in claim 11 wherein said determining by said advertising platform the placement of said at least one advertisement on an at least one display device occurs in near real time.

15. A digital advertising method as claimed in claim 11 further comprising creating and ingesting advertising media content by said advertising platform.

16. A digital advertising method as claimed in claim 11 further comprising optimizing by said advertising platform said at least one advertisement on said at least one display device.

17. A digital advertising method as claimed in claim 11 further comprising tracking by said at least one display device the usage of said at least one display device.

18. A digital advertising method as claimed in claim 11 further comprising obtaining information from interactions with a user, wherein said interactions are controlled by profile, settings, and privileges associated with an account types of said user

19. A digital advertising method as claimed in claim 11 wherein said advertising platform is an external cloud service.

20. A digital advertising method as claimed in claim 11 further comprising automatically installing on said at least one display device an advertising application when said at least one advertisement is placed on said at least one display device.
